(19) United States
(12) Patent Application Publication
(10) Pub. No.: US 2025/0281000 A1
(43) Pub. Date: Sep. 11, 2025

(54) Cutting Board Assembly

(71) Applicant: Kyle Johnson, Maple Grove, MN (US)

(72) Inventor: Kyle Johnson, Maple Grove, MN (US)

(21) Appl. No.: 18/596,743

(22) Filed: Mar. 6, 2024

(51) Int. Cl. A47J 47/00; A47J 47/20

(52) U.S. Cl. CPC A47J 47/005; A47J 47/20

(57) ABSTRACT

A cutting board assembly that is slidably mountable to a countertop while extending over a sink opening includes a panel upon which to position food for cutting. The panel has top and bottom sides, first and second lateral edges, and front and rear edges. A distance from the front to the rear edge is greater than a space from a front side to a back side of the sink opening. The panel is positionable on the upper surface so that the panel extends over the sink opening and is supported by the countertop. A plurality of stops is selectively movable and positioned on the bottom side. The stops extends downwardly from the bottom side and into the sink opening when the panel is positioned on the countertop. The stops are abuttable against a perimeter edge of the sink opening to restrict movement of the panel relative to the sink opening.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cutting boards and more particularly pertains to a new cutting board that is slidably mountable to a countertop. The prior art includes countertop positionable cutting boards which are not slidably mountable to a countertop while extending over a sink opening and which tend to slip and fall into a sink opening if they are positioned thereover.

### (2) Description of Related Art including information disclosed under 37 CFR 1.97 and 1.98

The prior art relates to cutting boards but which do not include movable stops on their bottom sides allowing the cutting boards to be slidably mountable to a countertop while extending over a sink opening.

### BRIEF SUMMARY OF THE INVENTION

An embodiment of the disclosure meets the needs presented above by generally comprising a cutting board assembly to position on an upper surface of countertop so that the cutting board assembly extends over a sink opening positioned in the countertop. The cutting board assembly comprises a panel upon which to position food for cutting. The panel has a top side, a bottom side, a first lateral edge, a second lateral edge, a front edge, and a rear edge. A distance from the front edge to the rear edge is greater than a space from a front side to a back side of the sink opening. The panel is positionable on the upper surface so that the panel extends over the sink opening and is supported by the countertop. The stops of a plurality of stops are selectively movable and positioned on the bottom side. The plurality of stops extends downwardly from the bottom side and into the sink opening when the panel is positioned on the countertop. The stops are abuttable against a perimeter edge of the sink opening to restrict movement of the panel relative to the sink opening.

Another embodiment of the disclosure includes a method of slidably mounting a panel to a countertop with the panel extending over a sink opening. Steps of the method comprise a providing a cutting board assembly, according to the disclosure above, moving the stops along the bottom side of the panel so that the stops match the space between the front side and the back side of the sink opening, and positioning the panel on the upper surface of the countertop so that the stops are inserted into the sink opening to abut the perimeter edge of the sink opening along the front side and the back side of the sink opening.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a cutting board assembly according to an embodiment of the disclosure.

FIG. 2 is a bottom isometric perspective view of an embodiment of the disclosure.

FIG. 3 is a detail view of an embodiment of the disclosure.

FIG. 4 is a bottom view of an embodiment of the disclosure.

FIG. 5 is a cross-sectional view of an embodiment of the disclosure.

FIG. 6 is an in-use view of an embodiment of the disclosure.

FIG. 7 is an in-use view of an embodiment of the disclosure.

FIG. 8 is a flow diagram of a method utilizing an embodiment of the disclosure.

### DETAILED DESCRIPTION OF THE INVENTION

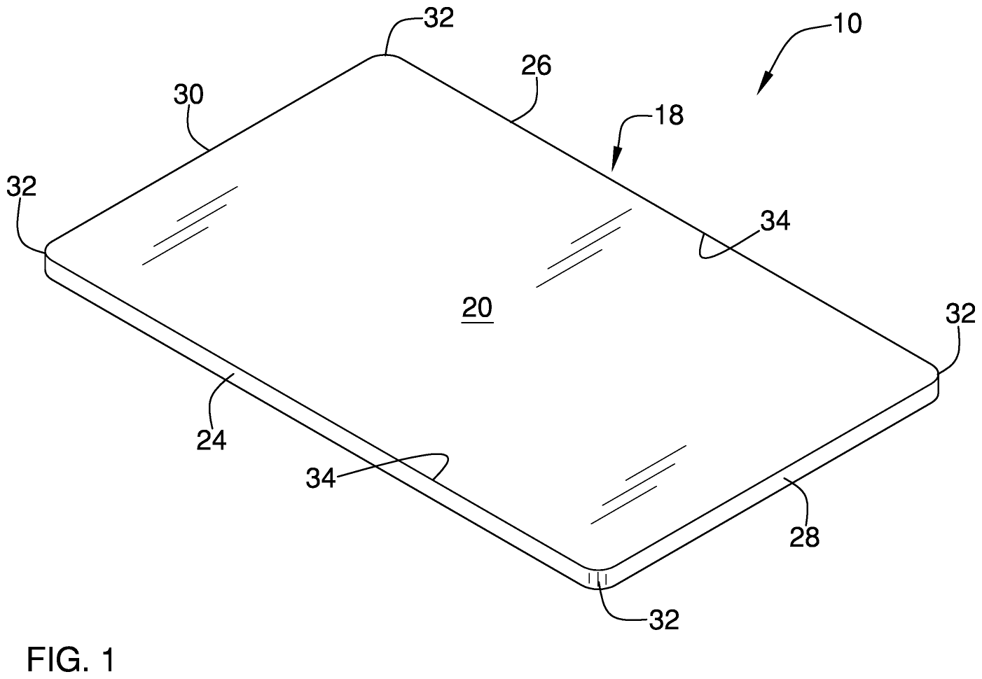

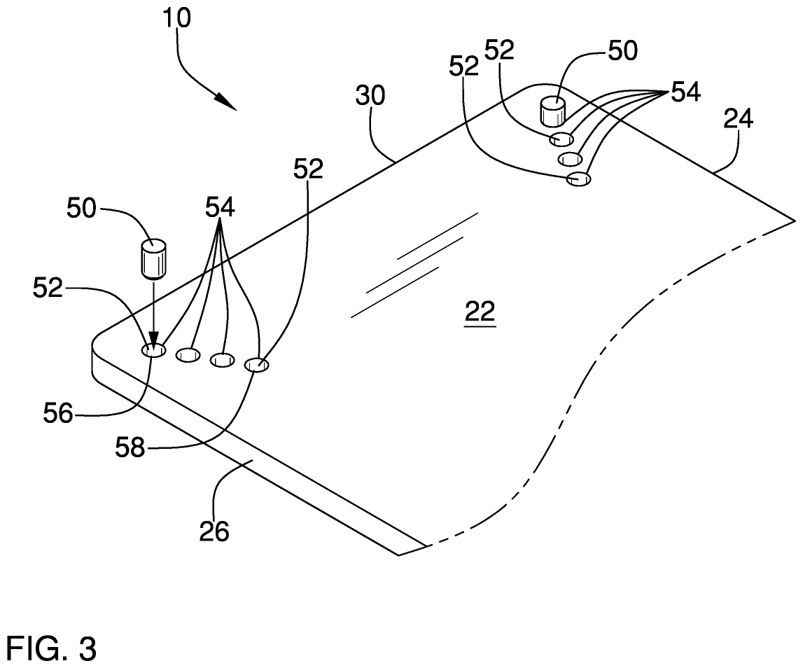

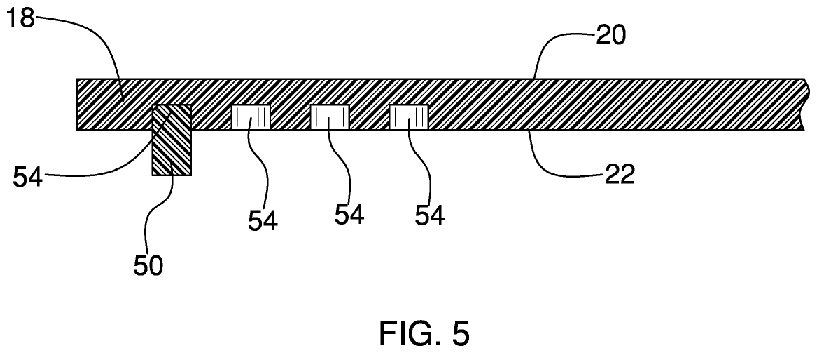

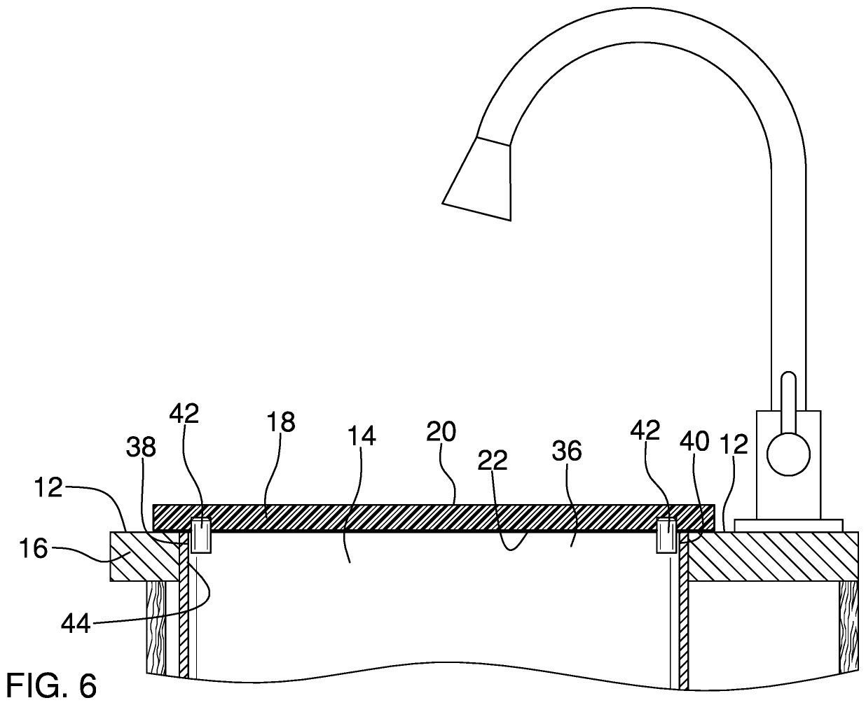

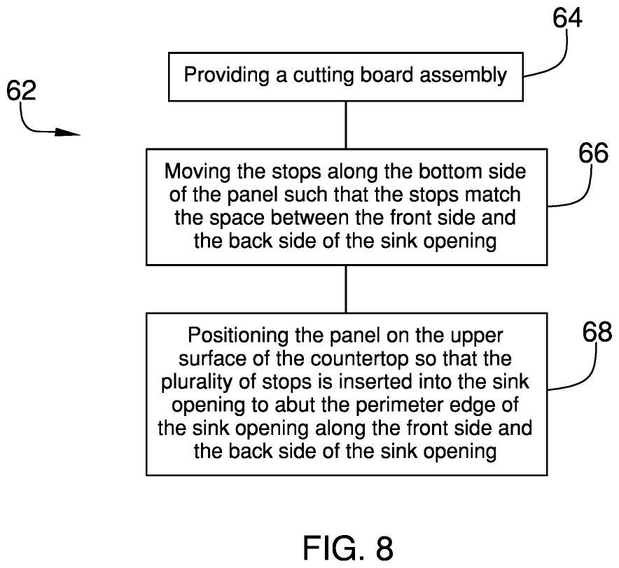

With reference now to the drawings, and in particular to FIGS. 1 through 8 thereof, a new cutting board embodying the principles and concepts of an embodiment of the disclosure and generally designated by the reference numeral 10 will be described.

As best illustrated in FIGS. 1 through 8, the cutting board assembly 10 to position on an upper surface 12 of a countertop 14 so that the cutting board assembly 10 extends over a sink opening 16 positioned in the countertop 14 generally comprises a panel 18 upon which to position food for cutting. The panel 18 has a top side 20, a bottom side 22, a first lateral edge 24, a second lateral edge 26, a front edge 28, and a rear edge 30. The panel 18 is substantially ridged and comprises one or more of wood, plastic, stone, metal, bamboo, cork, or any conventional material used for a cutting board. The panel 18 typically is substantially rectangular but also may be alternatively shaped, such as, but not limited to, circular, oval, or the like. As is shown in the figures, the panel 18 of one embodiment is rectangular and corners 32 of the panel 18 are rounded. A distance 34 from the front edge 28 to the rear edge 30 of the panel 18 is greater than a space 36 from a front side 38 to a back side 40 of the sink opening 16. The panel 18 thus is positionable on the upper surface 12 so that the panel 18 extends over the sink opening 16 and is supported by the countertop 14.

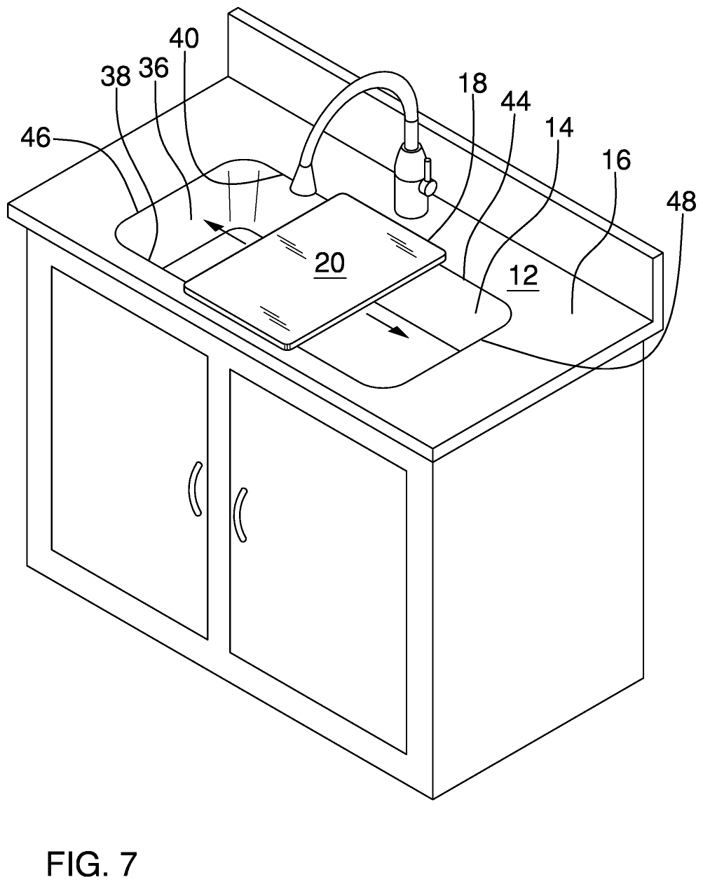

The stops 42 of a plurality of stops 42 are selectively movable and positioned on the bottom side 22. The plurality of stops 42 extends downwardly from the bottom side 22 and into the sink opening 16 when the panel 18 is positioned on the countertop 14. The stops 42 are abuttable against a perimeter edge 44 of the sink opening 16 to restrict movement of the panel 18 relative to the sink opening 16. Typically, the plurality of stops 42 would allow the panel 18 to be selectively slid between a left side 46 and a right side 48 of the sink opening 16, as is shown in FIG. 7. The panel 18 extends over the perimeter edge 44 of the sink opening 16 at the front side 38 and the back side 40 of the sink opening 16. It also is anticipated that the panel 18 could be sized to extend over the perimeter edge 44 of the sink opening 16 at the left side 46 and the right side 48 of the sink opening 16 and thus be slidable between the front side 38 and the back side 40 of the sink opening 16. Additionally anticipated is a configuration wherein stops 42 engage the perimeter edge 44 along each of the front side 38, the back side 40, the left side 46, and the right side 48 of the sink opening 16 so that the panel 18 covers and is substantially fixed relative to the sink opening 16.

An additional benefit of the cutting board assembly 10 is that one can use it on the countertop 14 and then can easily lift the panel 18 as the stops 42 elevate the panel 18 above the countertop 14. Prior art cutting boards often require sliding over an edge of the countertop 14 before they can be lifted.

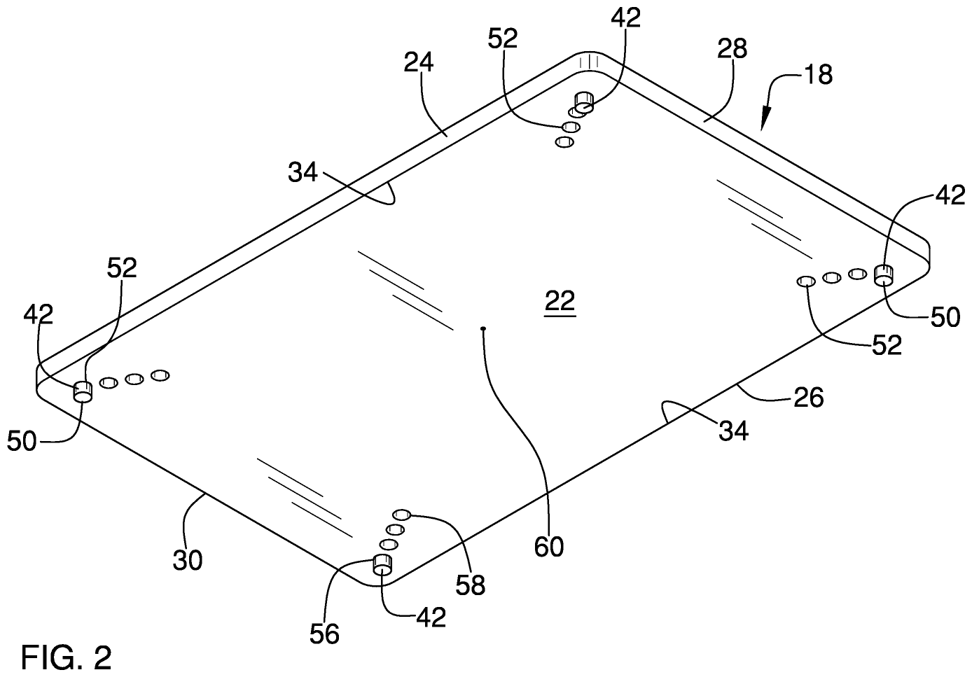

Each stop 42 may comprise a peg 50, as is shown in FIGS. 2-6. The peg 50 is selectively positionable on and attachable to the bottom side 22 of the panel 18. The present invention also anticipates the plurality of stops 42 comprising other stopping means, such as, but not limited to, extensible slats, protruding magnets, or the like.

The peg 50 may be selectively insertable into a respective recess 52 of a plurality of recesses 52 that extends into the bottom side 22. Each recess 52 has a respective spacing either of the front edge 28 or the rear edge 30. The peg 50 may be cylindrical, cuboid, elliptic cylinder, or the like. The peg 50 may be friction fit into the respective recess 52 to attach the peg 50 to the panel 18, although the present invention also anticipates other methods to reversibly attaching the pegs 50 to the panel 18, such as, but not limited to threading, twist locks, magnets, keyhole slots, suction cups, hook and loop fasteners, or the like.

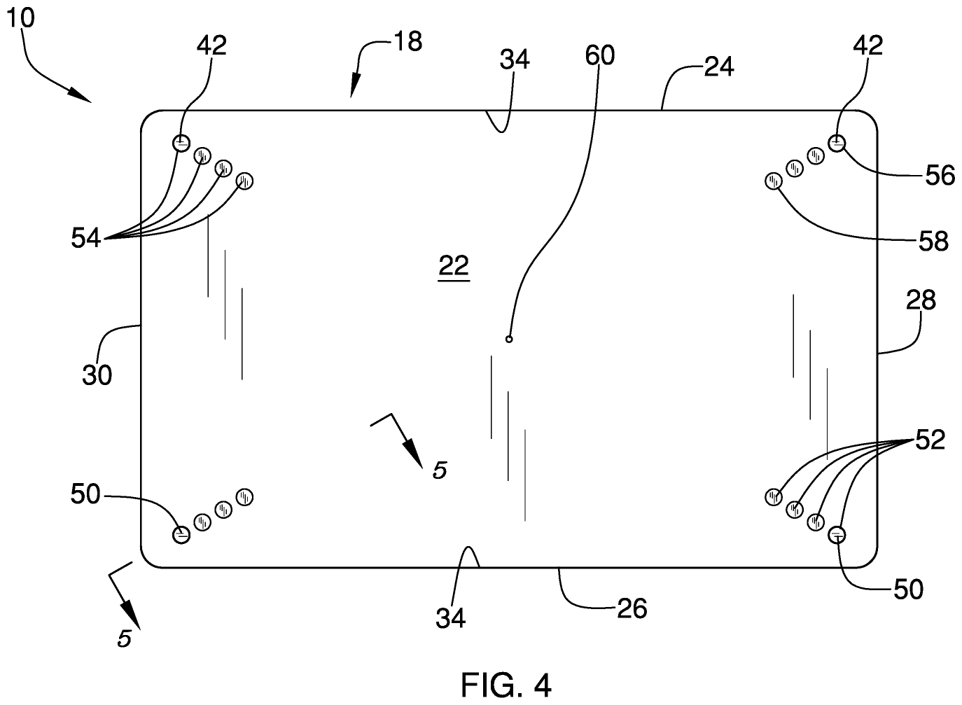

As is shown in FIG. 4, the plurality of stops 42 may comprise four stops 42 and the plurality of recesses 52 therefore comprises four sets of wells 54. Each set of wells 54 comprises at least three wells 54. Each set of wells 54 extends from proximate to one of the front edge 28 and the rear edge 30 toward the other of the front edge 28 and the rear edge 30 along one of the first lateral edge 24 and the second lateral edge 26.

The recesses 52 of each set of wells 54 may be aligned linearly so that an outermost well 56 of the set of wells 54 is closest to the one of the front edge 28 and the rear edge 30 and an innermost well 58 of the set of wells 54 is furthest from the one of the front edge 28 and the rear edge 30. The outermost well 56 of the set of wells 54 may be closest to one of the first lateral edge 24 and the second lateral edge 26 and the innermost well 58 of the set of wells 54 may be furthest from the one of the first lateral edge 24 and the second lateral edge 26. As such, each set of wells 54 extends from proximate to a respective corner 32 of the panel 18 generally toward a center 60 of the panel 18. This configuration allows for finer adjustment of the position of the stops 42, relative to sets of wells 54 that extend in parallel with the first lateral edge 24 and the second lateral edge 26, thereby enabling a tighter fit of the cutting board assembly 10 to the perimeter edge 44 of the sink opening 16.

In use, the cutting board assembly 10 enables a method 62 of slidably mounting a panel 18 to a countertop 14 with the panel 18 extending over a sink opening 16. The method 62 comprises a first step 64 of providing a cutting board assembly 10, according to the specification above. A second step 66 of the method 62 is moving the stops 42 along the bottom side 22 of the panel 18 so that the stops 42 match the space 36 between the front side 38 and the back side 40 of the sink opening 16. A third step 68 of the method 62 is positioning the panel 18 on the upper surface 12 of the countertop 14 so that the plurality of stops 42 is inserted into the sink opening 16 to abut the perimeter edge 44 of the sink opening 16 along the front side 38 and the back side 40 of the sink opening 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cutting board assembly for positioning on an upper surface of countertop such that the cutting board assembly extends over a sink opening positioned in the countertop, the cutting board assembly comprising:
a panel for positioning food upon such that the food may be cut, the panel having a top side, a bottom side, a first lateral edge, a second lateral edge, a front edge, and a rear edge, a distance from the front edge to the rear edge being greater than a space from a front side to a back side of the sink opening, wherein the panel is positionable on the upper surface such that the panel extends over the sink opening and is supported by the countertop; and
a plurality of stops being selectively movable and positioned on the bottom side, the plurality of stops extending downwardly from the bottom side and into the sink opening when the panel is positioned on the countertop, the plurality of stops being abuttable against a perimeter edge of the sink opening to restrict movement of the panel relative to the sink opening.

2. The cutting board assembly of claim 1, wherein each stop comprises a peg, the peg being selectively positionable on and attachable to the bottom side of the panel.

3. The cutting board assembly of claim 2, wherein the peg is selectively insertable into a respective recess of a plurality of recesses extending into the bottom side, each recess having a respective spacing either of the front edge and the rear edge.

4. The cutting board assembly of claim 3, wherein:
the plurality of stops comprises four stops; and
the plurality of recesses comprising four sets of wells, each set of wells extending from proximate to one of the front edge and the rear edge toward the other of the front edge and the rear edge along one of the first lateral edge and the second lateral edge.

5. The cutting board assembly of claim 4, wherein each set of wells is linear such that an outermost well of the set of wells is closest to the one of the front edge and the rear edge and an innermost well of the set of wells is furthest from the one of the front edge and the rear edge.

6. The cutting board assembly of claim 5, wherein the outermost well of the set of wells is closest to the respective one of the first lateral edge and the second lateral edge and the innermost well of the set of wells is furthest from the respective one of the first lateral edge and the second lateral edge.

7. The cutting board assembly of claim 3, wherein the peg is cylindrical.

8. The cutting board assembly of claim 3, wherein the peg is friction fit into the respective recess for attaching the peg to the panel.

9. The cutting board assembly of claim 4, wherein each set of wells comprises at least three wells.

10. The cutting board assembly of claim 1, wherein the panel comprises one or more of wood, plastic, stone, metal, bamboo, or cork.

11. The cutting board assembly of claim 1, wherein the panel is substantially rectangular.

12. A method of slidably mounting a panel to a countertop with the panel extending over a sink opening, the method comprising the steps of:
providing a cutting board assembly for positioning on an upper surface of countertop such that the cutting board assembly extends over a sink opening positioned in the countertop, the cutting board assembly comprising:
a panel for positioning food upon such that the food may be cut, the panel having a top side, a bottom side, a first lateral edge, a second lateral edge, a front edge, and a rear edge, a distance from the front edge to the rear edge being greater than a space from a front side to a back side of the sink opening, wherein the panel is positionable on the upper surface such that the panel extends over the sink opening and is supported by the countertop; and
a plurality of stops being selectively movable and positioned on the bottom side, the plurality of stops extending downwardly from the bottom side and into the sink opening when the panel is positioned on the countertop, the plurality of stops being abuttable against a perimeter edge of the sink opening to restrict movement of the panel relative to the sink opening;
moving the stops along the bottom side of the panel such that the stops match the space between the front side and the back side of the sink opening; and
positioning the panel on the upper surface of the countertop such that the plurality of stops is inserted into the sink opening to abut the perimeter edge of the sink opening along the front side and the back side of the sink opening.

13. The method of claim 12, wherein each stop comprises a peg, the peg being selectively positionable on and attachable to the bottom side of the panel.

14. The method of claim 13, wherein the peg is selectively insertable into a respective recess of a plurality of recesses extending into the bottom side, each recess having a respective spacing from either the front edge or the rear edge.

15. The method of claim 14, wherein:
the plurality of stops comprises four stops; and
the plurality of recesses comprising four sets of wells, each set of wells extending from proximate to one of the front edge and the rear edge toward the other of the front edge and the rear edge along one of the first lateral edge and the second lateral edge.

16. The method of claim 15, wherein each set of wells is linear such that an outermost well of the set of wells is closest to the one of the front edge and the rear edge and an innermost well of the set of wells is furthest from the one of the front edge and the rear edge.

17. The method of claim 16, wherein the outermost well of the set of wells is closest to one of the first lateral edge and the second lateral edge and the innermost well of the set of wells is furthest from the one of the first lateral edge and the second lateral edge.

18. The method of claim 14, wherein the peg is cylindrical.

19. The method of claim 14, wherein the peg is friction fit into the respective recess for attaching the peg to the panel.

20. The cutting board assembly of claim 15, wherein each set of wells comprises at least three wells.
